(19) United States
(12) Patent Application Publication
(10) Pub. No.: US 2003/0048692 A1
(43) Pub. Date: Mar. 13, 2003

(54) Apparatus for mixing, atomizing, and applying liquid coatings

(76) Inventors: Bernard Cohen, Berkeley Lake, GA (US); Lamar Heath Gipson, Acworth, GA (US); Lee Kirby Jameson, Roswell, GA (US)

Correspondence Address: Scott B. Garrison, Kimberly-Clark, Worldwide, Inc., Patent Department, 401 North Lake Street, Neenah, WI, 54956, US

(21) Appl. No.: 09/948,188

(22) Filed: Sep. 7, 2001

(51) Int. Cl. B01F 11/02

(52) U.S. Cl. 366/127; 366/605; 239/102.2; 239/142

(57) ABSTRACT

The present invention relates to an apparatus for mixing, atomizing, and applying liquid coatings onto a surface. The apparatus includes a housing and a means for applying ultrasonic energy to a portion of the pressurized liquid as the liquid passes through the housing. The housing includes a premixing chamber adapted to receive multi-component liquid under pressure, a mixing chamber in communication with the premixing chamber, an inlet adapted to supply the premixing chamber with the pressurized liquid, and an exit orifice adapted to pass the liquid out of the housing. When the means for applying ultrasonic energy is excited, it applies ultrasonic energy to the pressurized liquid contained within the mixing chamber without mechanically vibrating the tip.

### BACKGROUND OF THE INVENTION

The present invention relates to an apparatus for mixing, atomizing, and applying liquid coatings onto a surface. Current spraying systems use secondary atomizing air or extremely high pressures to atomize and drive a sprayed liquid to the target surface. In addition, the paint supply for high volume spray painting operations must be tinted in volume and held in storage until transferred to a spray gun.

### SUMMARY OF THE INVENTION

The present invention provides an apparatus for mixing, atomizing, and applying liquid coatings onto a surface. The invention allows the atomization of liquids without relying upon atomizing or propellant gases, or elevated pressures. In addition, the particle size distribution in the atomized plume of liquid coating is narrowed, the particle size is lowered, and particle velocities are increased. This invention enables a base liquid, such as paint, to be mixed with another component at the point of use. For example, colorants or tints can be added to paints, and catalysts can be added to epoxy resins. The invention eliminates the need to premix the constituent components. Proper mixing of the components is accomplished at the point of use. The mixing can be selectively altered in real time. The invention eliminates the need to accommodate premixed batches. Catalyzed coatings such as epoxy paints benefit in that pot life constraints are eliminated. Moreover, higher proportions of catalyst can be used enabling shorter cure time without fear of premature reaction. Additionally, the structure of the invention minimizes clogging of the exit orifice, i.e., the apparatus is self-cleaning.

In one aspect, the present invention comprises a mixing apparatus adapted to mix a multi-component liquid. The apparatus comprises a housing having a premixing chamber contained within the housing. A mixing chamber is placed in contiguous communication with the premixing chamber. The mixing chamber may contain an entrance with a cross-sectional area having a central axis which is normal to the cross-sectional area of the entrance. An exit orifice is provided which leads from the mixing chamber to an exterior of the apparatus. An ultrasonic horn terminating in a tip is provided. The ultrasonic horn has a nodal plane and a mechanical excitation axis. The ultrasonic horn may be affixed to the housing at substantially this nodal plane so that the tip resides within the premixing chamber. The tip of the ultrasonic horn also has a cross-sectional area. The central axis of the cross-sectional area of the entrance to the mixing chamber and the mechanical excitation axis of the cross-sectional area of the tip may be in close proximity and may also be substantially coaxially aligned and substantially equal in area. Vibrational energy emanating from the tip of the ultrasonic horn when activated is transferred to the multi-component liquid contained within the mixing chamber.

In another aspect of the present invention a mixing apparatus is disclosed, the mixing apparatus is adapted to mix a liquid and comprises a premixing chamber and a mixing chamber. The mixing chamber is placed in contiguous communication with the premixing chamber. The mixing chamber may contain an entrance with a cross-sectional area having a central axis which is normal to the cross-sectional area of the entrance. An exit orifice leading from the mixing chamber is also provided. Moreover, an ultrasonic horn terminating in a tip is provided. The ultrasonic horn has a nodal plane and a mechanical excitation axis. The ultrasonic horn may be affixed to some portion of the apparatus at substantially this nodal plane so that the tip resides within the premixing chamber. The tip of the ultrasonic horn also has a cross-sectional area. The central axis of the cross-sectional area of the entrance to the mixing chamber and the mechanical excitation axis of the cross-sectional area of the tip may be in close proximity and may also be substantially coaxially aligned and substantially equal in area. Vibrational energy emanating from the tip of the ultrasonic horn when activated is transferred to the multi-component liquid contained within the mixing chamber.

In still another aspect, the invention comprises a mixing apparatus having a premixing chamber and a mixing chamber. The mixing chamber comprises a volume and has an entrance. The entrance to the mixing chamber has a cross-sectional area and a central axis normal to the cross-sectional area of the entrance. The mixing chamber may be in contiguous communication with the premixing chamber. An ultrasonic horn is provided. The ultrasonic horn has a mechanical excitation axis and terminates in a tip having a cross-sectional area. The tip resides within the premixing chamber. The central axis of the cross-sectional area of the entrance to the mixing chamber and the mechanical excitation axis of the cross-sectional area of the tip may be in close proximity and may be substantially coaxially aligned and substantially equal in area. Vibrational energy emanating from the tip of the ultrasonic horn when activated is transferred to the volume of the mixing chamber but not to the mixing apparatus.

In yet still another aspect, the present invention comprises a mixing apparatus having a mixing chamber. The mixing chamber has a volume and an entrance. The entrance to the mixing chamber has a cross-sectional area and a central axis normal to the cross-sectional area. An ultrasonic horn having a mechanical excitation axis and terminating in a tip is also provided. The tip of the ultrasonic horn has a cross-sectional area. The central axis of the cross-sectional area of the entrance to the mixing chamber and the mechanical excitation axis of the cross-sectional area of the tip may be in close proximity and may be substantially coaxially aligned and substantially equal in area. Vibrational energy emanating from the tip of the ultrasonic horn when activated is transferred to the volume of the mixing chamber but not to the mixing apparatus.

### Definitions

As used herein, the term “liquid” refers to an amorphous (noncrystalline) form of matter intermediate between gases and solids, in which the molecules are much more highly concentrated than in gases, but much less concentrated than in solids. A liquid may have a single component or may be made of multiple components. The components may be other liquids, solids and/or gases. For example, a characteristic of liquids is their ability to flow as a result of an applied force. Liquids that flow immediately upon application of force and for which the rate of flow is directly proportional to the force applied are generally referred to as Newtonian liquids. Some liquids have abnormal flow response when force is applied and exhibit non-Newtonian flow properties.

As used herein, the term “node” or “nodal plane” means the point on the mechanical excitation axis of the ultrasonic horn at which no mechanical excitation motion of the horn occurs upon excitation by ultrasonic energy. The node sometimes is referred in the art, as well as in this specification, as the nodal point or nodal plane.

The term “close proximity” is used herein in a qualitative sense only. That is, the term is used to mean that the means for applying ultrasonic energy is sufficiently close to the entrance of the mixing chamber to apply the ultrasonic energy primarily to the reservoir of liquid contained within the mixing chamber. The term is not used in the sense of defining specific distances from the mixing chamber.

As used herein, the term “consisting essentially of” does not exclude the presence of additional materials which do not significantly affect the desired characteristics of a given composition or product. Exemplary materials of this sort would include, without limitation, pigments, antioxidants, stabilizers, surfactants, waxes, flow promoters, catalysts, solvents, particulates and materials added to enhance processability of the composition.

### BRIEF DESCRIPTION OF THE DRAWINGS

FIG. 1 is a diagrammatic cross-sectional representation of one embodiment of the apparatus of the present invention.

FIG. 2 is an enlarged view of an end of the diagrammatic cross-sectional representation of FIG. 1.

FIG. 3 is a diagrammatic cross-sectional representation of another embodiment of the apparatus of the present invention.

### DETAILED DESCRIPTION

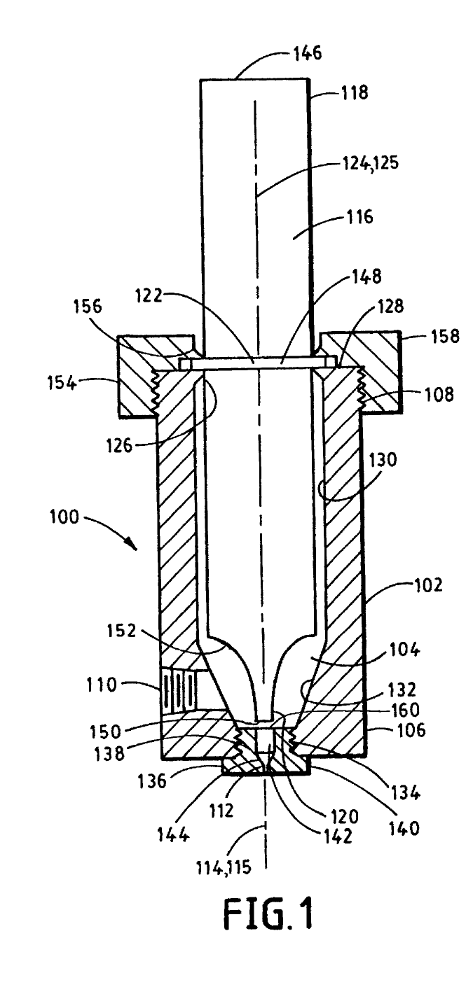

Generally speaking, the present invention comprises a mixing apparatus 100 adapted to mix a multi-component liquid. Looking to FIG. 1, there is shown, not necessarily to scale, an exemplary apparatus for imparting vibrational energy to a liquid enabling it to mix, flow, and atomize more readily without increasing the pressure or temperature of the liquid. The apparatus 100 is adapted to receive a multi-component liquid under pressure via an inlet 110. Such liquids include paints, stains, epoxies, and the like. The apparatus 100 comprises a housing 102 having a premixing chamber 104 which may in some embodiments be contained within the housing 102.

A mixing chamber 142 may be placed in contiguous communication with the premixing chamber 104 as depicted in FIG. 1. The mixing chamber 142 may contain an entrance 160 with a cross-sectional area having a central axis 115 which is normal to the cross-sectional area of the entrance 160. An exit orifice or orifices 112 may also be provided. The exit orifice 112 or orifices 112 lead from the mixing chamber 142 to an exterior of the apparatus 100 and are adapted to pass the liquid out of the housing 102. The mixing chamber 142 may be machined into the walls of the housing 102 or alternatively the housing 102 may comprise one or more sections (not shown) that when attached one to the other contain the inlet 110, exit orifice or orifices 112, premixing chamber 104, and mixing chamber 142.

The housing 102 has a first end 106 and a second end 108. The housing 102 may also comprise the inlet 110 which in turn is connected to the premixing chamber 104. The inlet 110 is adapted to supply the apparatus 100 and more specifically the premixing chamber 104 with the multi-component liquid to be ultimately mixed, atomized and sprayed. This first end 106 of the housing 102 may terminate in a tip 136. The tip 136 may comprise a separate, interchangeable component as depicted in FIG. 1.

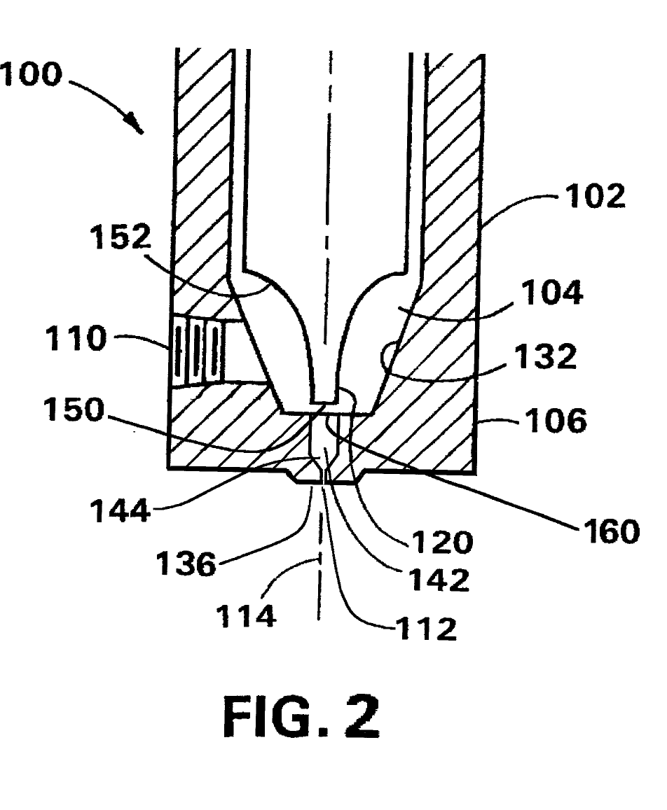

Alternatively, FIG. 2 depicts the tip 136 as an integral element of the housing 102. Furthermore, the tip 136 is not required to protrude from the housing 102 as shown in FIGS. 1 and 2. The exit orifice 112 located in the tip 136 is adapted to receive the mixed multi-component liquid from the mixing chamber 142 and spray the liquid out of the housing 102 and onto a surface (not shown).

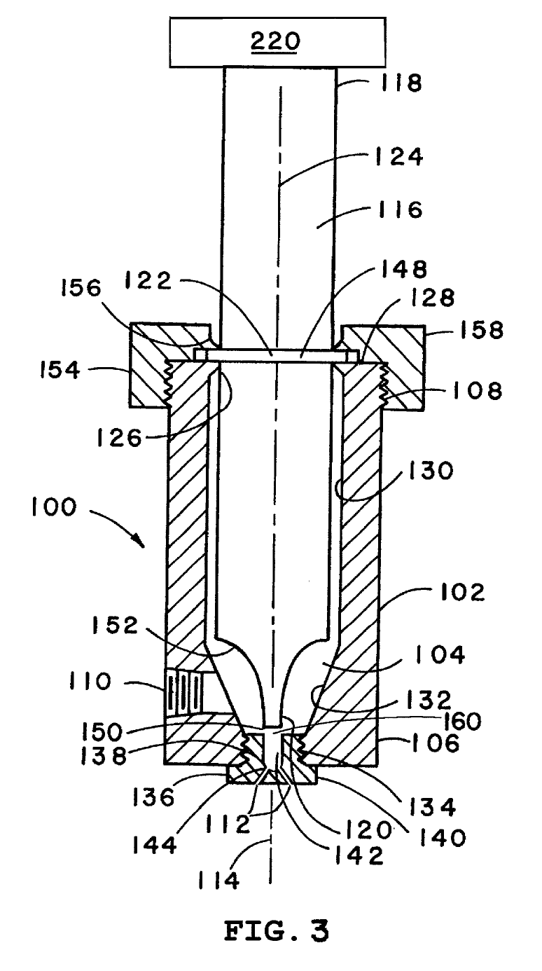

Looking to FIG. 2 for additional detail, it can be seen that the mixing chamber 142 is disposed between the premixing chamber 104 and the exit orifice 112. The mixing chamber 142 serves as a reservoir for the multi-component liquid received from the premixing chamber 104. The mixing chamber 142 also serves as the focal point to which the vibrational energy is directed. From the mixing chamber 142, the liquid now excited by the application of ultrasonic energy is passed to the exit orifice 112. The mixing chamber 142 may be directly connected to the exit orifice 112 or alternatively the two may be interconnected via a passageway 144 such as the frustoconical passageway depicted in FIG. 2 or the parabolic passageway depicted in FIG. 3.

Moreover, the mixing chamber 142 may define a volume which can be equal to, smaller than, or larger than the volume of the premixing chamber 104. In any event, in this embodiment, the path between the premixing chamber 104 and the mixing chamber 142 is contiguous and is formed by a transitional region or entrance 160 having a cross-sectional area. This entrance 160 may be formed in the side walls of the apparatus 100 which leads from the premixing chamber 104 to the mixing chamber 142.

In an aspect of the present invention, the exit orifice 112 may have a diameter of less than about 0.1 inch (2.54 mm). For example, the exit orifice 112 may have a diameter of from about 0.0001 to about 0.1 inch (0.00254 to 2.54 mm) As a further example, the exit orifice 112 may have a diameter of from about 0.001 to about 0.01 inch (0.0254 to 0.254 mm). The mixing chamber 142 may have a diameter of about 0.125 inch (about 3.2 mm) terminating in the passageway 144 which in turn leads to the exit orifice 112. The passageway 144 may have frustoconical walls, however, other configurations are contemplated as well. For instance, the embodiment of FIG. 2 depicts passageway 144 having about a 30 degree convergence as measured from a central axis 115 through the passageway 144. Whereas the embodiment of FIG. 3 depicts a parabolic shape as measured from a central axis 115 through the passageway 144.

According to the invention, the exit orifice 112 may be a single exit orifice or a plurality of exit orifices. The exit orifice 112 may be in the form of an exit capillary. As such, the exit orifice 112 may have a length to diameter ratio (L/D ratio) desirably ranging from about 4:1 to about 10:1. However, the exit orifice 112 may have a L/D ratio of less than 4:1 or greater than 10:1.

Looking once again to FIG. 1, a means for applying ultrasonic energy is provided. Desirably this means comprises an ultrasonic horn 116. The ultrasonic horn 116 has a first end 118, a second end 120, a nodal point or plane 122, a mechanical excitation axis 124, and a tip 150.

According to one aspect of the invention, it is desirable that the ultrasonic horn 116 be affixed in such a manner that no significant vibrational energy is transferred into the housing 102 itself. In some embodiments, the ultrasonic horn 116 may be affixed to the housing 102 at substantially this nodal plane 122 so that the only portion of the horn 116 to contact the housing 102 is that portion lying on the nodal plane 122. Additionally the horn 116 may be mounted so that the tip 150 resides within the premixing chamber 104.

In some embodiments, the ultrasonic horn 116 is located in the second end 108 of the housing 102 and is fastened at its node 122 in a manner such that the first end 118 of the horn 116 is located outside of the housing 102 and the second end 120 is located inside the housing 102, within the premixing chamber 104, and is in close proximity but does not cross an imaginary plane defined by the entrance 160 to the mixing chamber 142.

Alternatively, both the first end 118 and the second end 120 of the horn 116 may be located inside the housing 102 so long as no significant vibrational energy is transmitted from the horn 116 to the housing 102. One manner of accomplishing this, as stated, is to affix the horn 102 at its node 122 to the housing 102. Other methods of incorporating the ultrasonic horn 116 into the invention are contemplated as well, so long as these configurations induce no significant vibrational energy to the housing 102 or to the exit orifice 112.

The tip 150 of the ultrasonic horn 116 defines a cross-sectional area. As previously stated, the mixing chamber 142 has a corresponding cross-sectional area at the entrance 160 of the mixing chamber 142. In some desirable embodiments, a central axis 125 through this cross-sectional area of the tip 150 corresponds to a longitudinal mechanical excitation axis 124, whereas a central axis 115 through the cross-sectional area at the entrance 160 of the mixing chamber 142 corresponds to a first axis 114 through the mixing chamber 142.

The first axis 114 and the mechanical excitation axis 124 may be substantially coaxially aligned, and may be substantially in close proximity. The cross-sectional area of the tip 150 and the cross-sectional area of the entrance 160 may also be substantially equal in area. In some embodiments, the first axis 114 and the mechanical excitation axis 124 of the ultrasonic horn 116 are substantially parallel. In some embodiments, the first axis 114 and the mechanical excitation axis 124 substantially coincide. In other embodiments, the first axis 114 and the mechanical excitation axis 124 actually coincide, as shown in FIG. 1.

However, if desired, the mechanical excitation axis 124 of the horn 116 may be at an angle to the first axis 114. For example, the horn 116 may extend through a wall 130 of the housing 102, rather than through an end 106,108. Moreover, neither the first axis 114 nor the mechanical excitation axis 124 of the horn 116 need be vertical.

As already noted, the term “close proximity” is used herein to signify that the means for applying ultrasonic energy is sufficiently close to the area defining the entrance 160 to the mixing chamber 142 leading to the exit orifice 112 to apply the ultrasonic energy primarily to the pressurized multi-component liquid passing from the mixing chamber 142 into the exit orifice 112.

The actual distance between the tip 150 of the ultrasonic horn 116 and the exit orifice 112 in any given situation will depend upon a number of factors, some of which are the flow rate and/or viscosity of the pressurized multi-component liquid, the cross-sectional area of the tip 150 of the ultrasonic horn 116 relative to the cross-sectional area of the exit orifice 112, the cross-sectional area of tip 150 of the ultrasonic horn 116 relative to the cross-sectional area of the entrance 160 of the mixing chamber 142, the frequency of the ultrasonic energy, the gain of the means for applying the ultrasonic energy (e.g., the magnitude of the mechanical excitation mechanical excitation of the ultrasonic horn 116), the temperature of the pressurized liquid, and the rate at which the liquid passes out of the exit orifice 112.

In general, the distance between the tip 150 of the ultrasonic horn 116 and the termination of the exit orifice 112 in the first end 106 of the housing 102 in any given situation may be determined readily by one having ordinary skill in the art without undue experimentation. In practice, such distance will be in the range of from about 0.002 inch (about 0.05 mm) to about 1.3 inches (about 33 mm), although greater distances can be employed. Notwithstanding, the distance between the tip 150 of the ultrasonic horn 116 and an imaginary plane formed across the entrance 160 of the mixing chamber 142 can range from about 0 inches (about 0 mm) to about 0.100 inch (about 2.5 mm).

It is believed that the distance between the tip 150 of the ultrasonic horn 116 and this plane formed across the entrance 160 of the mixing chamber 142 determines the extent to which energy is applied to liquid within the premixing chamber 104 versus the most desirable situation of applying energy solely to the liquid contained within the mixing chamber 142 itself i.e., the greater the distance between the tip 150 and the plane formed across the entrance 160 to the mixing chamber 142, the greater the amount of energy lost to liquid not contained within the mixing chamber 142.

Consequently, shorter distances generally are desired in order to minimize energy losses, degradation of the pressurized liquid, and other adverse effects which may result from exposure of the liquid to the ultrasonic energy. In some embodiments, these distances range from about no protrusion of the tip 150 into the entrance 160 of the mixing chamber 104 to about 0.010 inch (about 0.25 mm) separation between the tip 150 and the plane formed across the entrance 160 to the mixing chamber 142. In one desirable embodiment, the tip 150 and the entrance 160 of the mixing chamber 142 are separated by a distance of about 0.005 inch (about 0.13 mm).

Under operation, the mixing chamber 142 receives liquid directly from the premixing chamber 104 and passes it to the exit orifice 112 or exit orifices 112. The liquid contained within the mixing chamber 142 is subjected to vibrational energy supplied by the ultrasonic horn 116. As such, the ultrasonic horn 116 is desirably located within the premixing chamber 104 but terminates in close proximity to the mixing chamber 142 without actually being wholly or partially contained within the mixing chamber 142 itself.

To ensure that the greatest quantity of vibrational energy is transferred into the liquid, the ultrasonic horn 116 may comprise a vibrational tip 150 or surface having an area which is equal to the area defined by the entrance 160 of the mixing chamber 142. Moreover, this vibrational tip 150 or surface is desirably both coaxially aligned with and in parallel spaced relation to the entrance 160 to the mixing chamber 142. This configuration focuses the vibrational energy into the liquid contained within the mixing chamber 142.

The apparatus 100 has the ability to increase the flow rates of multi-component liquids without increasing the pressure or temperature of the liquid supply. The apparatus 100 and method of the present invention may also be used to emulsify multi-component liquids as well as enable additives and contaminants to remain emulsified in such liquids.

In order to generate ultrasonic vibrations in the horn 116, the ultrasonic horn 116 itself may further comprise a vibrator means 220, as depicted in FIG. 3, coupled to the first end 118 of the horn 116. The vibrator means 220 may be a piezoelectric transducer or a magnetostrictive transducer.

The transducer may be coupled directly to the horn as shown in FIG. 3 or by means of an elongated waveguide (not illustrated). The elongated waveguide may have any desired input:output mechanical excitation ratio, although ratios of 1:1 and 1:1.5 are typical for many applications. The ultrasonic energy typically will have a frequency of from about 15 kHz to about 500 kHz, although other frequencies are contemplated as well. The vibrator means 220 causes the horn 116 to vibrate along the mechanical excitation axis 124. In the present embodiment, the ultrasonic horn 116 will vibrate about the nodal plane 122 at the ultrasonic frequency that is applied to the first end 118 by the vibrator means 220.

In some embodiments of the present invention, the ultrasonic horn 116 may be composed partially or entirely of a magnetostrictive material. In these embodiments, the horn 116 may be surrounded by a coil (which may also be immersed in the multi-component liquid) capable of inducing a signal into the magnetostrictive material causing it to vibrate at ultrasonic frequencies. In such cases, the ultrasonic horn 116 may simultaneously function as the vibrator means 220 and the ultrasonic horn 116 itself. In any event, vibrational energy emanating from the tip 150 of the ultrasonic horn 116 when the horn 116 is activated is transferred to the multi-component liquid contained within the mixing chamber 142. As stated, in some embodiments such as in FIG. 3, the present invention contemplates the use of an ultrasonic horn 116 having a vibrator means 220 coupled directly to the first end 118 of the horn 116. The vibrator means 220 may be a piezoelectric transducer or a magnetostrictive transducer.

During operation a small amount of energy may be lost to the multi-component liquid contained within the premixing chamber 104 itself but a very significant majority of the energy is directed into the multi-component liquid contained within the mixing chamber 142 without significantly vibrating the exit orifice 112 itself. One manner of maximizing the energy transferred from the horn 116 into the liquid contained within the mixing chamber 142 is to minimize or desirably eliminate any surface of the horn 116 from being perpendicular to the vibrational motion of the horn 116 itself, i.e., along the mechanical excitation axis 124, with the exception of the tip 150 of the horn 116 itself which serves as the focal point of the vibrational energy. By axially aligning the tip 150 of the horn 116 in parallel spaced relation to the entrance 160 to the mixing chamber 142, the vibrational energy can be focused into the liquid contained within the mixing chamber 142 itself.

The size and shape of the apparatus 100 can vary widely, depending, at least in part, based upon the number and arrangement of exit orifices 112 and the operating frequency of the ultrasonic horn 116. For example, the housing 102 may be cylindrical, rectangular, or any other shape. Moreover, since the housing 102 may have a plurality of exit orifices 112, the exit orifices 112 may be arranged in a pattern, including but not limited to, a linear or a circular pattern. Each of the exit orifices 112 may be associated with a dedicated mixing chamber 142, and each mixing chamber 142 may further include a dedicated ultrasonic horn 116.

Alternatively, a plurality of exit orifices 112 might be associated with a single mixing chamber 142 as shown in FIG. 3. Furthermore, the cross-sectional profile of the exit orifice 112 and the orientation of the exit orifice 112 with respect to the mechanical excitation axis 124 does not result in a negative impact on the use of the apparatus 100 as a mixing apparatus or flow control apparatus.

The application of ultrasonic energy to a plurality of exit orifices 112 may be accomplished by a variety of methods. For example, with reference again to the use of an ultrasonic horn 116, the second end 120 of the horn 116 may have a cross-sectional area which is sufficiently large so as to apply ultrasonic energy to the portion of the liquid in the vicinity of all of the exit orifices 112 in the housing 102. In such case, the second end 120 of the ultrasonic horn 116 desirably will have a cross-sectional area approximately the same size as the area defining the entrance 160 to the mixing chamber 142 in the housing 102.

Alternatively, although not depicted, the second end 120 of the horn 116 may have a plurality of protrusions, or tips 150, equal in number to the number of individual mixing chambers 142 leading to exit orifices 112. In this instance, the cross-sectional area of each protrusion or tip 150 desirably will be approximately the same as the cross-sectional area comprising the entrance 160 to each respective mixing chamber 142 with which any specific protrusion or tip 150 is in close proximity.

One advantage of the apparatus 100 of the present invention is that it is self-cleaning. That is, the combination of the pressure at which the liquid is supplied to the premixing chamber 104 and the forces generated by ultrasonically exciting the ultrasonic horn 116 can remove obstructions that appear to block the exit orifice 112 without significantly vibrating the housing 102 or the orifice exit 112.

According to the invention, the exit orifice 112 is adapted to be self-cleaning when the ultrasonic horn 116 is excited with ultrasonic energy while the exit orifice 112 receives pressurized multi-component liquid from the premixing chamber 142 via the mixing chamber 104 and through the passageway 144, if one is present, and passes the liquid out of the housing 102. The vibrations imparted by the ultrasonic energy appear to change the apparent viscosity and flow characteristics of the high viscosity liquids.

Furthermore, the vibrations also appear to improve the flow rate of the liquids traveling through the apparatus 100. The vibrations cause breakdown and flushing out of clogging contaminants at the exit orifice 112. The vibrations can also cause emulsification of the multi-component liquid with other components (e.g., liquid components) or additives that may be present in the stream.

The present invention is further described by the example which follows. The example, however, is not to be construed as limiting in any way either the spirit or the scope of the present invention.

### EXAMPLE

### Ultrasonic Horn Apparatus

The following is a description of an exemplary ultrasonic horn apparatus of the present invention generally as shown in the FIGs. incorporating some of the more desirable features described above.

With reference to FIG. 1, the housing 102 of the apparatus was a cylinder having an outer diameter of 1.375 inches (about 34.9 mm), an inner diameter of 0.875 inch (about 22.2 mm), and a length of 3.086 inches (about 78.4 mm). The outer 0.312-inch (about 7.9-mm) portion of the second end 108 of the housing was threaded with 16-pitch threads. The inside of the second end had a beveled edge 126, or chamfer, extending from the face 128 of the second end toward the first end 106 a distance of 0.125 inch (about 3.2 mm). The chamfer reduced the inner diameter of the housing at the face of the second end to 0.75 inch (about 19.0 mm). An inlet 110 (also called an inlet orifice) was drilled in the housing, the center of which was 0.688 inch (about 17.5 mm) from the first end, and tapped. The inner wall of the housing consisted of a cylindrical portion 130 and a conical frustrum portion 132. The cylindrical portion extended from the chamfer at the second end toward the first end to within 0.992 inch (about 25.2 mm) from the face of the first end. The conical frustrum portion extended from the cylindrical portion a distance of 0.625 inch (about 15.9 mm), terminating at a threaded opening 134 in the first end. The diameter of the threaded opening was 0.375 inch (about 9.5 mm); such opening was 0.367 inch (about 9.3 mm) in length.

A tip 136 was located in the threaded opening of the first end. The tip consisted of a threaded cylinder 138 having a circular shoulder portion 140. The shoulder portion was 0.125 inch (about 3.2 mm) thick and had two parallel faces (not shown) 0.5 inch (about 12.7 mm) apart. An exit orifice 112 (also called an extrusion orifice) was drilled in the shoulder portion and extended toward the threaded portion a distance of 0.087 inch (about 2.2 mm). The diameter of the extrusion orifice was 0.0145 inch (about 0.37 mm). The extrusion orifice terminated within the tip at a mixing chamber 142 having a diameter of 0.125 inch (about 3.2 mm) and a conical frustrum passage 144 which joined the mixing chamber with the extrusion orifice. The wall of the conical frustrum passage was at an angle of 30□ from the vertical. The mixing chamber extended from the extrusion orifice to the end of the threaded portion of the tip, thereby connecting the premixing chamber defined by the housing with the extrusion orifice.

The means for applying ultrasonic energy was a cylindrical ultrasonic horn 116. The horn was machined to resonate at a frequency of 20 kHz. The horn had a length of 5.198 inches (about 132.0 mm), which was equal to one-half of the resonating wavelength, and a diameter of 0.75 inch (about 19.0 mm). The face 146 of the first end 118 of the horn was drilled and tapped for a ⅜-inch (about 9.5-mm) stud (not shown). The horn was machined with a collar 148 at the nodal point 122. The collar was 0.0945 inch (about 2.4-mm) wide and extended outwardly from the cylindrical surface of the horn 0.062 inch (about 1.6 mm). The horn 116 was affixed to the housing 102 at the collar 148. By affixing the horn to the housing at the nodal point of the horn, the transfer of vibrational energy to the housing was eliminated or at least substantially minimized. The diameter of the horn at the collar was 0.875 inch (about 22.2 mm). The second end 120 of the horn terminated in a small cylindrical tip 150 0.125 inch (about 3.2 mm) long and 0.125 inch (about 3.2 mm) in diameter. Such tip 150 was separated from the cylindrical body of the horn by a parabolic frustrum portion 152 approximately 0.5 inch (about 13 mm) in length. That is, the curve of this frustrum portion as seen in cross-section was parabolic in shape. The face of the small cylindrical tip 150 was normal to the cylindrical wall of the horn and was located about 0.005 inch (about 0.13 mm) from an imaginary plane across the entrance to the mixing chamber. Thus, the face of the tip of the horn, i.e., the second end of the horn 150, was located immediately above the entrance to the mixing chamber and was the same area as the planar area across the entrance of the mixing chamber.

The first end 108 of the housing was sealed by a threaded cap 154 which also served to hold the ultrasonic horn in place. The threads extended upwardly toward the top of the cap a distance of 0.312 inch (about 7.9 mm). The outside diameter of the cap was 2.00 inches (about 50.8 mm) and the length or thickness of the cap was 0.531 inch (about 13.5 mm). The opening in the cap was sized to accommodate the horn; that is, the opening had a diameter of 0.75 inch (about 19.0 mm). The edge of the opening in the cap was a chamfer 156 which was the mirror image of the chamfer at the second end of the housing. The thickness of the cap at the chamfer was 0.125 inch (about 3.2 mm), which left a space between the end of the threads and the bottom of the chamfer of 0.094 inch (about 2.4 mm), which space was the same as the length of the collar on the horn. The diameter of such space was 1.104 inch (about 28.0 mm). The top 158 of the cap had drilled in it four ¼-inch diameter×¼-inch deep holes (not shown) at 90□ intervals to accommodate a pin spanner. Thus, the collar of the horn was compressed between the two chamfers upon tightening the cap, thereby sealing the premixing chamber defined by the housing.

A Branson elongated aluminum waveguide having an input:output mechanical excitation ratio of 1:1.5 was coupled to the ultrasonic horn by means of a ⅜-inch (about 9.5-mm) stud. To the elongated waveguide was coupled a piezoelectric transducer, a Branson Model 502 Converter, which was powered by a Branson Model 1120 Power Supply operating at 20 kHz (Branson Sonic Power Company, Danbury, Conn.). Power consumption was monitored with a Branson Model A410A Wattmeter.

### Related Patents and Applications

This application is one of a group of commonly assigned patents and patent applications. The group includes application Ser. No. 08/576,543 entitled “An Apparatus And Method For Emulsifying A Pressurized Multi-Component Liquid”, Docket No. 12535, in the name of L. K. Jameson et al.; application Ser. No. 08/576,536, now granted U.S. Pat. No. 6,053,424, entitled “An Apparatus And Method For Ultrasonically Producing A Spray Of Liquid”, Docket No. 12536, in the name of L. H. Gipson et al.; application Ser. No. 08/576,522 entitled “Ultrasonic Fuel Injection Method And Apparatus”, Docket No. 12537, in the name of L. H. Gipson et al.; application Ser. No. 08/576,174, now granted U.S. Pat. No. 5,803,106, entitled “An Ultrasonic Apparatus And Method For Increasing The Flow Rate Of A Liquid Through An Orifice”, Docket No. 12538, in the name of B. Cohen et al.; and application Ser. No. 08/576,175, now granted U.S. Pat. No. 5,868,153, entitled “Ultrasonic Flow Control Apparatus And Method”, Docket No. 12539, in the name of B. Cohen et al.; provisional application No. 60/254,737 entitled “Ultrasonic Fuel Injector with Ceramic Valve Body”, Docket No. 15781, in the name of Jameson et al.; provisional application No. 60/254,683 entitled “Unitized Injector Modified for Ultrasonically Stimulated Operation”, Docket No. 15872, in the name of Jameson et al.; provisional application No. 60/257,593 entitled “Ultrasonically Enhanced Continuous Flow Fuel Injection Apparatus and Method”, Docket No. 15810, in the name of Jameson et al.; and provisional application No. 60/258,194 entitled “Apparatus and Method to Selectively Microemulsify Water and Other Normally Immiscible Fluids into the Fuel of Continuous Combustors at the Point of Injection”, in the name of Jameson et. al. The subject matter of each of these applications is hereby incorporated by reference.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A mixing apparatus adapted to mix a multi-component liquid comprising:
a housing;
a premixing chamber contained within the housing;
a mixing chamber comprising an entrance with a cross-sectional area having a central axis normal to the cross-sectional area of the entrance, the mixing chamber in contiguous communication with the premixing chamber;
an exit orifice leading from the mixing chamber; and
an ultrasonic horn terminating in a tip, the ultrasonic horn having a nodal plane and a mechanical excitation axis, the ultrasonic horn being affixed to the housing at substantially the nodal plane, the tip residing within the premixing chamber and having a cross-sectional area;
wherein the central axis of the cross-sectional area of the entrance to the mixing chamber and the mechanical excitation axis of the cross-sectional area of the tip are in close proximity and are substantially coaxially aligned and substantially equal in area;
whereby vibrational energy emanating from the tip of the ultrasonic horn is transferred to the multi-component liquid contained within the mixing chamber.

2. The apparatus of claim 1 wherein the premixing chamber defines a first volume and the mixing chamber comprises a second smaller volume.

3. The apparatus of claim 1 wherein the premixing chamber defines a first volume and the mixing chamber comprises a second larger volume.

4. The apparatus of claim 1, wherein the mixing chamber is interconnected with the exit orifice via a passageway.

5. The apparatus of claim 1, wherein the ultrasonic horn is a magnetostrictive ultrasonic horn immersed in the liquid.

6. The apparatus of claim 1, wherein the exit orifice comprises a plurality of exit orifices.

7. The apparatus of claim 1, wherein the tip of the horn is about 0 inches to about 0.100 inches from the entrance to the mixing chamber.

8. The apparatus of claim 1, wherein the exit orifice has a diameter of from about 0.0001 to about 0.1 inch.

9. The apparatus of claim 1, wherein the exit orifice has a diameter of from about 0.001 to about 0.01 inch.

10. The apparatus of claim 1, wherein the apparatus is self-cleaning.

11. The apparatus of claim 1, wherein the apparatus is a paint sprayer.

12. A mixing apparatus adapted to mix a liquid comprising:
a premixing chamber;
a mixing chamber comprising an entrance with a cross-sectional area having a central axis normal to the cross-sectional area of the entrance, the mixing chamber in contiguous communication with the premixing chamber;
an exit orifice leading from the mixing chamber; and
an ultrasonic horn terminating in a tip, the ultrasonic horn having a nodal plane and a mechanical excitation axis, the ultrasonic horn being affixed to the apparatus at substantially the nodal plane, the tip residing within the premixing chamber and having a cross-sectional area;
wherein the central axis of the cross-sectional area of the entrance to the mixing chamber and the mechanical excitation axis of the cross-sectional area of the tip are in close proximity and are substantially coaxially aligned and substantially equal in area;
whereby vibrational energy emanating from the tip of the ultrasonic horn is transferred to the liquid contained within the mixing chamber.

13. The apparatus of claim 12 wherein the premixing chamber defines a first volume and the mixing chamber comprises a second smaller volume.

14. The apparatus of claim 12 wherein the premixing chamber defines a first volume and the mixing chamber comprises a second larger volume.

15. The apparatus of claim 12, wherein the mixing chamber is interconnected with the exit orifice via a passageway.

16. The apparatus of claim 12, wherein the ultrasonic horn is a magnetostrictive ultrasonic horn immersed in the liquid.

17. The apparatus of claim 12, wherein the exit orifice comprises a plurality of exit orifices.

18. The apparatus of claim 12, wherein the tip of the horn is about 0 inches to about 0.100 inches from the entrance to the mixing chamber.

19. The apparatus of claim 12, wherein the exit orifice has a diameter of from about 0.0001 to about 0.1 inch.

20. The apparatus of claim 12, wherein the exit orifice has a diameter of from about 0.001 to about 0.01 inch.

21. The apparatus of claim 12, wherein the apparatus is self-cleaning.

22. The apparatus of claim 12, wherein the apparatus is a paint sprayer.

23. A mixing apparatus comprising:
a premixing chamber;
a mixing chamber comprising a volume and an entrance with a cross-sectional area having a central axis normal to the cross-sectional area of the entrance, the mixing chamber in contiguous communication with the premixing chamber; and
an ultrasonic horn terminating in a tip, the ultrasonic horn having a mechanical excitation axis, the tip residing within the premixing chamber and having a cross-sectional area;
wherein the central axis of the cross-sectional area of the entrance to the mixing chamber and the mechanical excitation axis of the cross-sectional area of the tip are in close proximity and are substantially coaxially aligned and substantially equal in area;
whereby vibrational energy emanating from the tip of the ultrasonic horn is transferred to the volume of the mixing chamber but not to the mixing apparatus.

24. A mixing apparatus comprising:
a mixing chamber having a volume and an entrance, the entrance having a cross-sectional area and a central axis normal to the cross-sectional area; and
an ultrasonic horn having a mechanical excitation axis and terminating in a tip, the tip having a cross-sectional area;
wherein the central axis of the cross-sectional area of the entrance to the mixing chamber and the mechanical excitation axis of the cross-sectional area of the tip are in close proximity and are substantially coaxially aligned and substantially equal in area;
whereby vibrational energy emanating from the tip of the ultrasonic horn is directed into the volume of the mixing chamber but not into the mixing apparatus.

25. A mixing apparatus for improving the flow of a multi-component liquid by the application of vibrational energy to the liquid, the apparatus comprising:
a housing;
a premixing chamber contained within the housing comprising a first volume, the chamber adapted to receive a pressurized multi-component liquid;
an inlet within the housing connected to the premixing chamber adapted to supply the premixing chamber with the pressurized multi-component liquid;
a mixing chamber having an entrance, the mixing chamber contained within the housing and in direct communication via the entrance with the premixing chamber, the mixing chamber comprising a second volume, smaller than the first volume of the premixing chamber, the entrance defining an area;
an exit orifice interconnected to the mixing chamber, the exit orifice adapted to receive the pressurized multi-component liquid from the mixing chamber and pass the multi-component liquid out of the housing; and
an ultrasonic horn having a nodal plane and a tip having a cross-sectional area, the horn being rigidly affixed to the housing such that the only portion of the horn to contact the housing is the nodal plane, the tip being disposed in substantially parallel spaced relation to the entrance of the mixing chamber, wherein the cross-sectional area of the tip is substantially coaxially aligned with and is substantially the same area as the area of the entrance to the mixing chamber.
